(19) United States
(12) Patent Application Publication
(10) Pub. No.: US 2023/0071661 A1
(43) Pub. Date: Mar. 9, 2023

(54) METHOD FOR TRAINING IMAGE EDITING MODEL AND METHOD FOR EDITING IMAGE

(71) Applicant: Beijing Baidu Netcom Science Technology Co., Ltd., Beijing (CN)

(72) Inventors: Haotian PENG, Beijing (CN); Ruizhi CHEN, Beijing (CN); Chen ZHAO, Beijing (CN)

(21) Appl. No.: 18/054,711

(22) Filed: Nov. 11, 2022

(30) Foreign Application Priority Data
Mar. 11, 2022 (CN) 202210237623.5

(51) Int. Cl. G06T 11/60; G06F 40/186; G06F 40/20; G06N 20/00

(52) U.S. Cl. CPC G06T 11/60; G06F 40/186; G06F 40/20; G06N 20/00

(57) ABSTRACT

The present disclosure provides a method for training an image editing model, a method for editing an image, apparatuses, a device, a storage medium and a computer program. An implementation plan is: acquiring a training sample set; and performing training steps as follows: selecting a description text sample and an image sample from the training sample set; determining a text direction vector based on the selected description text sample and a predetermined text template; inputting the text direction vector into a mapping network of the image editing model to obtain a bias vector; determining an image direction vector based on the selected image sample and the bias vector; calculating a loss value based on the text direction vector and the image direction vector; and determining, in response to the loss value meeting a threshold condition, that training of the image editing model is completed.

### CROSS-REFERENCE TO RELATED APPLICATIONS

This application claims priority to Chinese Patent Application No. 202210237623.5, filed with the China National Intellectual Property Administration (CNIPA) on Mar. 11, 2022, the contents of which are incorporated herein by reference in their entirety.

### TECHNICAL FIELD

The present disclosure relates to the technical field of artificial intelligence, in particular to the technical fields of virtual/augmented reality, computer vision and deep learning, and may be applied to scenarios such as image editing, and more particularly, to a method for training an image editing model, a method and apparatuses for editing an image, a device, a storage medium and a computer program product.

### BACKGROUND

Based on an input description text and a to-be-edited image, an image editing model may edit the to-be-edited image, to generate a target image corresponding to the description text, where the description text is a textual expression used to describe features of the target image. For example, the to-be-edited image is a face image expressing a happy emotion, and the description text may be “Emotion is sad”. The description text and the to-be-edited image are input into the image editing model, and a sad face image is output.

### SUMMARY

The present disclosure provides a method for training an image editing model, a method for editing an image, apparatuses, a device, a storage medium and a computer program product, which improves an efficiency of image editing.

In a first aspect, embodiments of the present disclosure provide a method for training an image editing model, comprising: acquiring a training sample set, wherein training samples comprise description text samples and image samples; and performing training steps as follows: selecting a description text sample and an image sample from the training sample set; determining a text direction vector based on the selected description text sample and a predetermined text template; inputting the text direction vector into a mapping network of the image editing model to obtain a bias vector; determining an image direction vector based on the selected image sample and the bias vector; calculating a loss value based on the text direction vector and the image direction vector; and determining, in response to the loss value meeting a threshold condition, that training of the image editing model is completed.

In a second aspect, embodiments of the present disclosure provide a method for editing an image, comprising: receiving an image editing request, wherein the image editing request comprises a to-be-edited image and a description text; and inputting the description text and the to-be-edited image into an image editing model, to generate a target image corresponding to the description text.

In a third aspect, embodiments of the present disclosure provide an apparatus for training an image editing model, comprising: an acquisition module, configured to acquire a training sample set, wherein training samples comprise description text samples and image samples; and a training module, configured to perform training steps as follows: selecting a description text sample and an image sample from the training sample set; determining a text direction vector based on the selected description text sample and a predetermined text template; inputting the text direction vector into a mapping network of the image editing model to obtain a bias vector; determining an image direction vector based on the selected image sample and the bias vector; calculating a loss value based on the text direction vector and the image direction vector; and determining, in response to the loss value meeting a threshold condition, that training of the image editing model is completed.

In a fourth aspect, embodiments of the present disclosure provide an apparatus for editing an image, comprising: a receiving module, configured to receive an image editing request, wherein the image editing request comprises a to-be-edited image and a description text; and a generation module, configured to input the description text and the to-be-edited image into an image editing model, to generate a target image corresponding to the description text.

In a fifth aspect, embodiments of the present disclosure provide an electronic device, comprising: one or more processors; and a memory, storing one or more programs, wherein the one or more programs, when executed by the one or more processors, cause the one or more processors to implement the method for training an image editing model provided by the first aspect or the method for editing an image provided by the second aspect.

In a sixth aspect, embodiments of the present disclosure provide a computer-readable medium, storing a computer program thereon, wherein the program, when executed by a processor, causes the processor to implement the method for training an image editing model provided by the first aspect or the method for editing an image provided by the second aspect.

In a seventh aspect, an embodiment of the present disclosure provides a computer program product, comprising a computer program, wherein the computer program, when executed by a processor, implements the method for training an image editing model provided by the first aspect or the method for editing an image provided by the second aspect.

It should be understood that the content described in this section is neither intended to identify key or important features of the embodiments of the present disclosure, nor intended to limit the scope of the present disclosure. Other features of the present disclosure will become understandable through the following description.

### BRIEF DESCRIPTION OF THE DRAWINGS

The accompanying drawings are used to better understand the present solution, and do not constitute a limitation to the present disclosure, in which:

FIG. 1 is an exemplary system architecture diagram to which the present disclosure may be applied;

FIG. 2 is a flowchart of an embodiment of a method for training an image editing model according to the present disclosure;

FIG. 3 is a flowchart of another embodiment of the method for training an image editing model according to the present disclosure;

FIG. 4 is a schematic diagram of the method for training an image editing model according to the present disclosure;

FIG. 5 is a flowchart of an embodiment of a method for editing an image according to the present disclosure;

FIG. 6 is an effect schematic diagram of the method for editing an image according to the present disclosure;

FIG. 7 is a schematic structural diagram of an embodiment of an apparatus for training an image editing model according to the present disclosure;

FIG. 8 is a schematic structural diagram of an embodiment of an apparatus for editing an image according to the present disclosure; and

FIG. 9 is a block diagram of an electronic device used to implement the method for training an image editing model or the method for editing an image according to an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope and spirit of the present disclosure. Similarly, for clearness and conciseness, descriptions of well-known functions and structures are omitted in the following description.

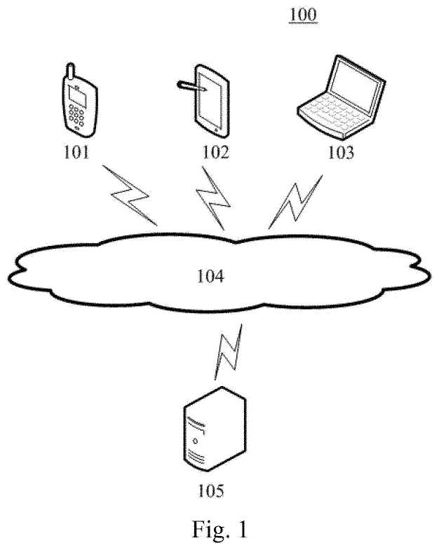

FIG. 1 illustrates an exemplary system architecture 100 to which an embodiment of a method for training an image editing model or a method for editing an image, or an apparatus for training an image editing model or an apparatus for editing an image of the present disclosure may be applied.

As shown in FIG. 1, the system architecture 100 may include terminal devices 101, 102, and 103, a network 104, and a server 105. The network 104 serves as a medium providing a communication link between the terminal devices 101, 102, 103, and the server 105. The network 104 may include various types of connections, such as wired or wireless communication links, or optical cables.

A user may use the terminal devices 101, 102, 103 to interact with the server 105 via the network 104 to acquire an image editing model or edit an image, or the like. Various client applications, such as text and image processing applications, may be installed on the terminal devices 101, 102, and 103.

The terminal devices 101, 102, and 103 may be hardware or software. When the terminal devices 101, 102, and 103 are hardware, they may be various electronic devices, including but not limited to smart phones, tablet computers, laptop computers, desktop computers, or the like. When the terminal devices 101, 102, and 103 are software, they may be installed in the above listed electronic devices. The terminal devices 101, 102, and 103 may be implemented as a plurality of software or software modules, or may be implemented as a single software or software module, which is not limited herein.

The server 105 may provide various services for training an image editing model or editing an image. For example, the server 105 may analyze and process text and images acquired from the terminal devices 101, 102, and 103, and generate a processing result (e.g., an edited image determined corresponding to the text, etc.).

It should be noted that the server 105 may be hardware or software. When the server 105 is hardware, it may be implemented as a distributed server cluster composed of a plurality of servers, or may be implemented as a single server; when the server 105 is software, it may be implemented as a plurality of software or software modules (such as for providing distributed services), or may be implemented as a single software or software module, which is not limited herein.

It should be noted that the method for training an image editing model or the method for editing an image provided by embodiments of the present disclosure is generally performed by the server 105, and accordingly, the apparatus for training an image editing model or the apparatus for editing an image is generally set in the server 105.

It should be understood that the numbers of terminal devices, networks, and servers in FIG. 1 are merely illustrative. Any number of terminal devices, networks, and servers may be provided according to implementation needs.

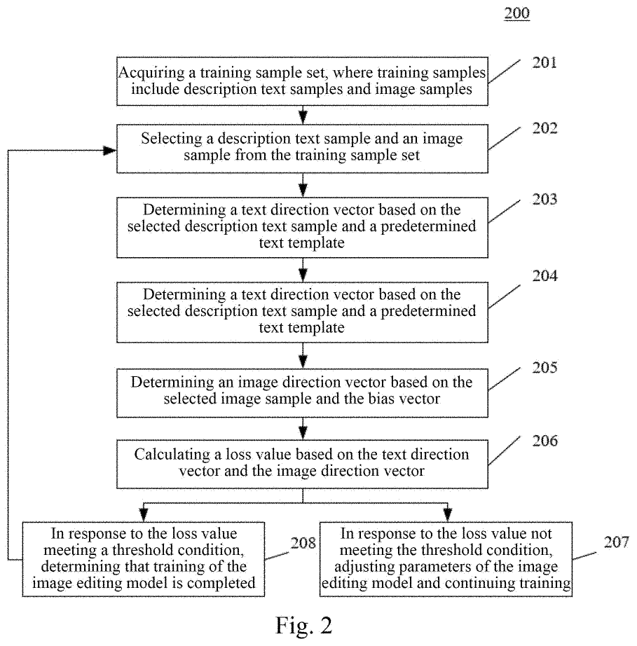

With further reference to FIG. 2, illustrating a flow 200 of an embodiment of a method for training an image editing model according to the present disclosure. The method for training an image editing model includes the following steps:

Step 201, acquiring a training sample set, where training samples include description text samples and image samples.

In the present embodiment, an executing body of the method for training an image editing model (for example, the server 105 shown in FIG. 1) may acquire the training sample set. The executing body may acquire an existing sample set stored in a public database, or may collect samples through a terminal device (for example, the terminal devices 101, 102, 103 shown in FIG. 1). In this way, the executing body may receive the samples collected by the terminal device and store these samples locally, thereby generating the training sample set.

The training sample set may include at least one sample. The samples may include description text samples and image samples. The description text sample is text used to describe features of an edited image. For example, the description text may be text used to describe facial organ features in an edited face image, or may be text used to describe character's emotions in an edited face image, for example, content of the description text is: long curly hair, big eyes, white skin, and long eyelashes. The image sample may be an animal image, a plant image, or a face image, which is not limited in the present disclosure.

In the technical solution of the present disclosure, the collection, storage, use, processing, transmission, provision and disclosure of the user personal information involved are all in compliance with relevant laws and regulations, and do not violate public order and good customs.

In some alternative implementations of the present embodiment, multiple articles with accompanying pictures may be acquired. Acquiring an accompanying picture from an article as an image sample, and acquiring text describing the accompanying picture, extracting multiple keywords from the text, as the description text sample corresponding to the accompanying picture, so that multiple image samples and multiple description text samples corresponding to the image samples may be obtained, to form the training sample set.

Step 202, selecting a description text sample and an image sample from the training sample set.

In the present embodiment, after acquiring the training sample set, the executing body may select one description text sample and one image sample from the training sample set. A description text sample and an image sample may be randomly selected from the training sample set, or an image sample may be randomly selected from the training sample set first, and then a description text sample corresponding to the image sample may be found from the training sample set, which is not limited in the present disclosure.

Step 203, determining a text direction vector based on the selected description text sample and a predetermined text template.

In the present embodiment, the executing body may determine the text direction vector based on the selected description text sample and the predetermined text template. The text template may be a phrase related to a literal meaning that the description text sample actually wants to express, or may be a related sentence, or may be a related piece of text, which is not limited in the present disclosure. The number of text templates may be one or more. The literal meaning that the description text sample actually wants to express may be pre-acquired, then a scenario to which the literal meaning is applicable may be acquired, or an object name that the literal meaning is applicable to describe may be acquired, and the applicable scenario or the applicable object name is used as the text template, or after acquiring the applicable scenario or the applicable object name, the applicable scenario or the applicable object name may be described in detail, expanded into a paragraph, and used as the text template. For example, the description text sample is beautiful, and the literal meaning that the description text sample actually wants to express is to describe a picture as beautiful, and further, a photo, a painting, or an image may be used as the text template. Using the text template may provide a context for reference when extracting features of the description text sample, so that the extracted features of the description text sample can be more accurate, thereby improving an accuracy of the text direction vector. At the same time, the more text templates are used, the more accurate the acquired text direction vector is. For example, the text direction vector may be determined based on 30-40 predetermined text templates.

The selected description text sample and the predetermined text template may be used as input data, and respectively input into a direction vector determination model, and the text direction vector corresponding to the description text sample may be output from an output end of the direction vector determination model. Here, the text direction vector represents text features of the description text sample, and represents a direction in feature space.

In some alternative implementations of the present embodiment, the selected description text sample may be added to each text template to obtain multiple spliced description text samples, and the multiple spliced description text samples may be input into another direction vector determination model, and the text direction vectors corresponding to the description text samples may be output from an output end of this direction vector determination model.

Step 204, inputting the text direction vector into a mapping network of the image editing model to obtain a bias vector.

In the present embodiment, after obtaining the text direction vector, the executing body may input the text direction vector into the mapping network of the image editing model to obtain the bias vector. The text direction vector is a 1*n-dimensional vector, and the bias vector is an m*n-dimensional vector generated by deforming the text direction vector. Both the bias vector and the text direction vector are vectors that represent the text features of the description text sample, but in different forms. The mapping network of the image editing model is a network for mapping a 1*n-dimensional vector to an m*n-dimensional vector, where m and n are both natural numbers greater than 1. The text direction vector may be used as input data and input into the mapping network of the image editing model, and the corresponding bias vector may be output from an output end of the mapping network.

Step 205, determining an image direction vector based on the selected image sample and the bias vector.

In the present embodiment, after obtaining the bias vector, the executing body may determine the image direction vector based on the selected image sample and the bias vector. An image vector corresponding to the image sample may be first acquired, then the image vector and the bias vector may be added to obtain a new image vector, the new image vector may be used as input data and input into an image direction vector generation model, and the corresponding image direction vector may be output from an output end of the image direction vector generation model.

Step 206, calculating a loss value based on the text direction vector and the image direction vector.

In the present embodiment, after obtaining the text direction vector and the image direction vector, the executing body may calculate the loss value based on the text direction vector and the image direction vector. A similarity between the text direction vector and the image direction vector may be calculated as the calculated loss value.

Based on the loss value, it may be determined whether a change in the image sample is in the same direction as the description text sample, so as to evaluate whether training of the mapping network of the image editing model is completed.

Step 207, determining, in response to the loss value meeting a threshold condition, that training of the image editing model is completed.

In the present embodiment, after obtaining the loss value, the executing body may determine whether the training of the image editing model is completed based on the loss value. The threshold condition may be a preset threshold, for example, the threshold condition is 80%, and the calculated loss value is compared with the threshold condition, if the loss value meets the threshold condition, for example, the loss value is greater than 80%, then it may be determined that the training of the image editing mode is completed.

Step 208, in response to the loss value not meeting the threshold condition, adjusting parameters of the image editing model and continuing training.

In the present embodiment, if the executing body determines that the loss value does not meet the threshold condition, for example, if the loss value is less than or equal to 80%, it may be determined that the training of the image editing model is not completed, then parameters of layers in the mapping network of the image editing model are adjusted, and a description text sample and an image sample are re-selected from the training sample set to continue training. The operation of selecting a description text sample and an image sample has been described in detail in step 202, detailed description thereof will be omitted.

The method for training an image editing model provided by this embodiment of the present disclosure, first acquiring a training sample set, then performing training steps as follows: selecting a description text sample and an image sample from the training sample set; determining a text direction vector based on the selected description text sample and a predetermined text template; inputting the text direction vector into a mapping network of the image editing model to obtain a bias vector; determining an image direction vector based on the selected image sample and the bias vector; calculating a loss value based on the text direction vector and the image direction vector; and determining, in response to the loss value meeting a threshold condition, that training of the image editing model is completed. The image editing model obtained based on the above training method may process any description text, improves an efficiency of image editing.

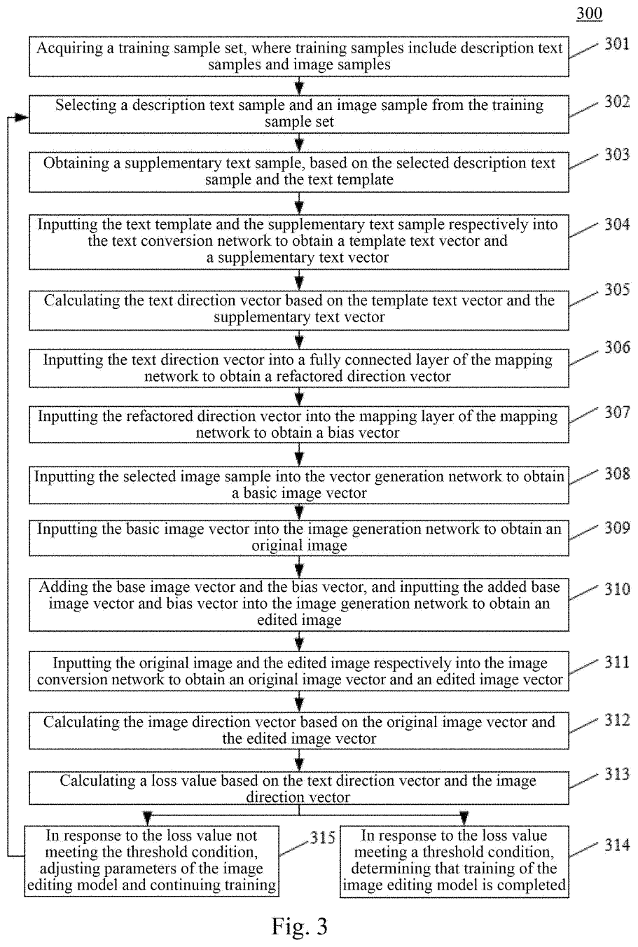

With further reference to FIG. 3, illustrating a flow 300 of another embodiment of the method for training an image editing model according to the present disclosure. The method for training an image editing model includes the following steps:

Step 301, acquiring a training sample set, where training samples include description text samples and image samples.

Step 302, selecting a description text sample and an image sample from the training sample set.

In the present embodiment, the operations of steps 301-302 have been described in detail in steps 201-202 in the embodiment shown in FIG. 2, detailed description thereof will be omitted.

Step 303, obtaining a supplementary text sample, based on the selected description text sample and the text template.

In the present embodiment, after obtaining the description text sample, the executing body may obtain the supplementary text sample, based on the description text sample. It should be noted that, in the present embodiment, the description text sample and the image sample may be used as input data and input into the image editing model. Each intermediate variable may be acquired based on the image editing model, and the image editing model may be trained based on a calculation result of the image editing model. The image editing model may include a text conversion network, a mapping network, an image conversion network, a vector generation network and an image generation network. The text conversion network may use a text as input, and output a 1*512-dimensional vector corresponding to the text. For example, the text conversion network may be a CLIP (Contrastive Language-Image Pre-training) text encoding network. The mapping network may use a 1*512-dimensional vector as input, and output a corresponding 18*512-dimensional vector. For example, the mapping network may be an MLP (Multi-layer Perceptron) network. The vector generation network may use an image as input, and output an 18*512-dimensional vector corresponding to the image. For example, the vector generation network may be an e4e (encoder4editing) network. The image generation network may use an 18*512-dimensional vector as input, and output an image corresponding to the vector. For example, the image generation network may be a StyleGAN (Style-based Generative Adversarial Network) network. The image conversion network may use an image as input, and output a 1*512-dimensional vector corresponding to the image. For example, the image conversion network may be a CLIP (Contrastive Language-Image Pre-training) image encoding network.

After inputting the description text sample into the image editing model, the description text sample is preprocessed first, and the text template in the image editing model may be acquired. The text template is pre-stored in the image editing model. The text template may be one or more, for example, the text template is “a/an ( ) photo”, “a/an ( ) painting”, “a/an ( ) image”. Then, the selected description text sample may be respectively embedded into each text template, and each text template has an insertion identifier reserved for indicating that text may be inserted at the position. For example, parentheses are used as the insertion identifier, the insertion identifier in each text template may be determined first, then the selected description text sample may be used to replace the insertion identifier, to generate a supplementary text sample, and so on, the same number of supplementary text samples as the text template may be acquired. For example, the selected description text sample is “beautiful”, and the generated supplementary text samples are “a beautiful photo”, “a beautiful painting”, and “a beautiful image”.

Step 304, inputting the text template and the supplementary text sample respectively into the text conversion network to obtain a template text vector and a supplementary text vector.

In the present embodiment, after obtaining the supplementary text sample, the executing body may generate the template text vector corresponding to the text template and the supplementary text vector corresponding to the supplementary text sample. The text template may be used as input data and input into the text conversion network of the image editing model, and the template text vector corresponding to the text template may be output from an output end of the text conversion network, where the number of template text vectors is the same as the number of input text templates, and each template text vector is a 1*512-dimensional vector. After obtaining the template text vector, the supplementary text sample may be again used as input data and input into the text conversion network of the image editing model, and the supplementary text vector corresponding to the supplementary text sample may be output from the output end of the text conversion network, where the number of supplementary text vectors is the same as the number of template text vectors, and each supplementary text vector is a 1*512-dimensional vector.

Step 305, calculating the text direction vector based on the template text vector and the supplementary text vector.

In the present embodiment, after obtaining the template text vector and the supplementary text vector, the executing body may calculate the text direction vector based on the template text vector and the supplementary text vector. The text direction vector may be calculated according to the following formula:

$${Y}_{t} = {\sum }_{i}^{n} \frac{C ( {T}_{x i} ) - C ( {T}_{i} )}{n}$$

where Yₜ represents the text direction vector, i is the i^{th} text template or the i^{th} supplementary text sample, C(Tₓᵢ) represents the i^{th} supplementary text vector, C(Tᵢ) represents the i^{th} template text vector, and n is a total of n text templates or n supplementary text samples.

Step 306, inputting the text direction vector into a fully connected layer of the mapping network to obtain a refactored direction vector.

In the present embodiment, after obtaining the text direction vector, the executing body may input the text direction vector into the fully connected layer of the mapping network to obtain the refactored direction vector. It should be noted that the mapping network of the image editing model includes the fully connected layer and a mapping layer. The fully connected layer may use a 1*512-dimensional vector as input, and output a corresponding 18*512-dimensional vector. The mapping layer may use an 18*512-dimensional vector as input, and output a corresponding mapped 18*512-dimensional vector.

The text direction vector is a 1*512-dimensional vector. The text direction vector may be used as input data and input into the fully connected layer of the mapping network of the image editing model, and an 18*512-dimensional vector corresponding to the text direction vector may be output from an output end of the fully connected layer, where the output 18*512-dimensional vector is the refactored direction vector. The refactored direction vector and the text direction vector are only different in vector dimension, but they both represent the same vector direction in vector space.

Step 307, inputting the refactored direction vector into the mapping layer of the mapping network to obtain a bias vector.

In the present embodiment, after obtaining the refactored direction vector, the executing body may input the refactored direction vector into the mapping layer of the mapping network to obtain the bias vector. The refactored direction vector may be used as input data and input into the mapping layer of the mapping network of the image editing model, and a mapped 18*512-dimensional vector corresponding to the refactored direction vector may be output from an output end of the mapping layer, where the output 18*512-dimensional vector is the bias vector.

The refactored direction vector has 18 layers. The mapping layer may define the 0-3 layers of the refactored direction vector as a rough layer, the 4-7 layers as an intermediate layer, and the 8-17 layers as a fine layer to obtain the bias vector. For example, the description text sample is text used to describe face features, so the obtained bias vector is also a vector used to describe the face features, then the rough layer of the bias vector is mainly used to control features such as posture, hair, or face shape, the intermediate layer is mainly used to control facial features such as eyes, and the fine layer is mainly used to control color matching. The rough layer and the intermediate layer have a greater impact on the face features, while the fine layer has no obvious impact on the face features. Therefore, the present embodiment can only focus on the features of the rough layer and the intermediate layer.

In the technical solution of the present disclosure, the collection, storage, use, processing, transmission, provision and disclosure of the user personal information involved are all in compliance with relevant laws and regulations, and do not violate public order and good customs.

Step 308, inputting the selected image sample into the vector generation network to obtain a basic image vector.

In the present embodiment, after obtaining the selected image sample, the executing body may input the selected image sample into the vector generation network to obtain the basic image vector. The selected image sample may be used as input data and input into the vector generation network of the image editing model, and the basic image vector corresponding to the selected image sample may be output from an output end of the vector generation network, where the basic image vector is an 18*512-dimensional vector representing image features of the image sample.

Step 309, inputting the basic image vector into the image generation network to obtain an original image.

In the present embodiment, after obtaining the basic image vector, the executing body may input the basic image vector into the image generation network to obtain the original image. The basic image vector may be used as input data and input into the image generation network of the image editing model, and the original image corresponding to the basic image vector may be output from an output end of the image generation network. Since the image generated by the image generation network is not exactly the same as the selected image sample, and there are differences, it is a necessary step of generating the original image based on the image generation network.

Step 310, adding the base image vector and the bias vector, and inputting the added base image vector and bias vector into the image generation network to obtain an edited image.

In the present embodiment, after obtaining the base image vector and the bias vector, the executing body may add the base image vector and the bias vector, and input the added base image vector and bias vector into the image generation network to obtain the edited image. Both the base image vector and the bias vector are an 18*512-dimensional vector. The base image vector is generated by the vector generation network. 18 layers of the base image vector consist of three parts: rough layer, intermediate layer, and fine layer. The bias vector has been described in detail in step 307, and the bias vector also consists of three parts: rough layer, intermediate layer, and fine layer. A vector structure of the base image vector and the bias vector is consistent. Therefore, the base image vector and the bias vector may be directly added. For example, the description text sample is text used to describe face features, then the obtained bias vector is also a vector used to describe the face features. The image sample is an image corresponding to a description content of the description text sample. Therefore, the image sample may be a face image, and the basic image vector represents face features of the image sample. After adding the basic image vector and the bias vector, a new vector may be obtained, which represents a new face feature vector obtained by adding the face features described by the bias vector on the basis of the face features of the image sample.

In the technical solution of the present disclosure, the collection, storage, use, processing, transmission, provision and disclosure of the user personal information involved are all in compliance with relevant laws and regulations, and do not violate public order and good customs.

After obtaining the vector obtained by adding the basic image vector and the bias vector, the vector obtained by adding may be used as input data and input into the image generation network of the image editing model, and the edited image corresponding to the vector obtained by adding may be output from the output end of the image generation network.

Step 311, inputting the original image and the edited image respectively into the image conversion network to obtain an original image vector and an edited image vector.

In the present embodiment, after obtaining the original image and the edited image, the executing body may input the original image and the edited image respectively into the image conversion network to obtain the original image vector and the edited image vector. The original image may be used as input data and input into the image conversion network of the image editing model, and the original image vector corresponding to the original image may be output from an output end of the image conversion network, where the original image vector represents image features of the original image. The edited image may be used as input data and input into the image conversion network of the image editing model, and the edited image vector corresponding to the edited image may be output from the output end of the image conversion network, where the edited image vector represents image features of the edited image. Both the original image vector and the edited image vector are a 1*512-dimensional vector.

Step 312, calculating the image direction vector based on the original image vector and the edited image vector.

In the present embodiment, after obtaining the original image vector and the edited image vector, the executing body may calculate the image direction vector based on the original image vector and the edited image vector. The image direction vector may be calculated according to the following formula:

Yᵢ=C(A)−C(B)

where Yᵢ represents the image direction vector, C(A) represents the original image vector, and C(B) represents the edited image vector.

Step 313, calculating a loss value based on the text direction vector and the image direction vector.

Step 314, determining, in response to the loss value meeting a threshold condition, that training of the image editing model is completed.

Step 315, in response to the loss value not meeting the threshold condition, adjusting parameters of the image editing model and continuing training.

In the present embodiment, the operations of steps 313-315 have been described in detail in steps 206-208 in the embodiment shown in FIG. 2, detailed description thereof will be omitted.

It should be noted that the loss value may be calculated according to the following formula:

loss=1−cos(Yᵢ,Yₜ)

where loss is the calculated loss value, Yᵢ represents the image direction vector, and Yₜ represents the text direction vector.

As can be seen from FIG. 3, compared with the embodiment corresponding to FIG. 2, the method for training an image editing model in the present embodiment acquires the text direction vector based on the text template, so that the obtained text direction vector is more accurate. Based on the mapping network of the image editing model, a high degree of decoupling of the spatial relationship of the text direction vector is realized, so as to adapt to the vector structure output by the vector generation network. Based on the image generation network and the image conversion network, the image direction vector is generated, realizing the mapping relationship between the text direction vector and the image direction vector, so that the image editing model is trained by determining whether the text direction and the image change direction are in the same direction. By using a training method of alternately inputting the description text sample and the image sample for training, the image editing model obtained by training may input any description text to generate a target image, which further improves the efficiency of image editing. At the same time, the image editing model obtained by training is lightweight and unified, a space size is optimized, and management difficulty is reduced.

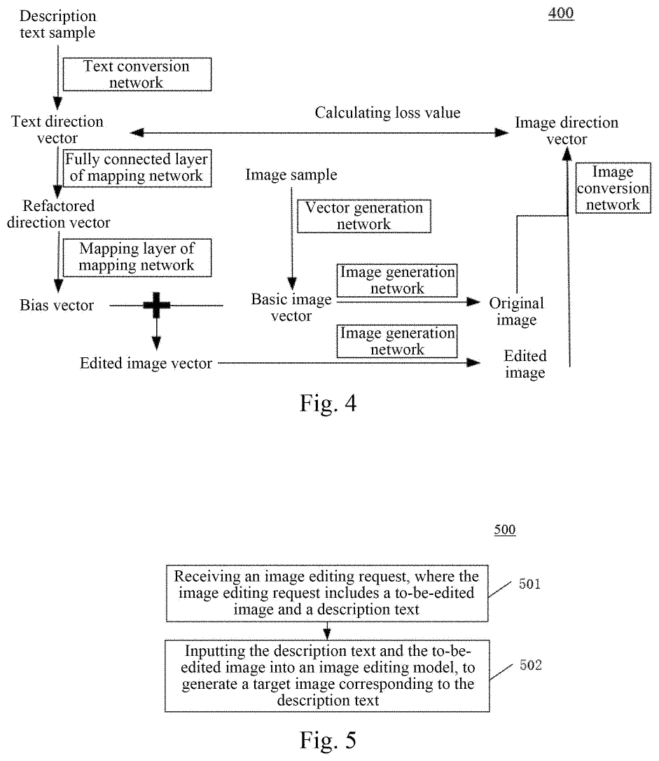

With further reference to FIG. 4, illustrating a schematic diagram 400 of the method for training an image editing model according to the present disclosure. As can be seen from FIG. 4, first, the description text sample may be input into the text conversion network of the image editing model to obtain the template text vector and the supplementary text vector, then, based on the template text vector and the supplementary text vector, the text direction vector is calculated. The text direction vector is input into the fully connected layer of the mapping network of the image editing model to obtain the refactored direction vector, and the refactored direction vector is input into the mapping layer of the mapping network of the image editing model to obtain the bias vector. Then, the image sample is input into the vector generation network of the image editing model to obtain the basic image vector, the basic image vector is input into the image generation network of the image editing model to obtain the original image. The basic image vector and the bias vector are added and input into the image generation network of the image editing model to obtain the edited image. The original image and the edited image are respectively input into the image conversion network of the image editing model to obtain the original image vector and the edited image vector. Based on the original image vector and the edited image vector, the image direction vector is calculated. Based on the text direction vector and the image direction vector, the loss value is calculated to train the image editing model, so that the efficiency of image editing of the trained image editing model is improved.

With further reference to FIG. 5, illustrating a flow 500 of an embodiment of a method for editing an image according to the present disclosure. The method for editing an image includes the following steps:

Step 501, receiving an image editing request, where the image editing request includes a to-be-edited image and a description text.

In the present embodiment, the executing body may receive the image editing request. The image editing request may be in the form of voice or text, which is not limited in the present disclosure. The image editing request includes the to-be-edited image and the description text. The to-be-edited image may be an animal image, a plant image, or a face image, which is not limited in the present disclosure. The description text is text used to describe features of an edited image. For example, the description text may be text used to describe facial organ features in an edited face image, or may be text used to describe character's emotions in an edited face image, for example, content of the description text is: long curly hair, big eyes, white skin, long eyelashes.

In the technical solution of the present disclosure, the collection, storage, use, processing, transmission, provision and disclosure of the user personal information involved are all in compliance with relevant laws and regulations, and do not violate public order and good customs.

Step 502, inputting the description text and the to-be-edited image into an image editing model, to generate a target image corresponding to the description text.

In the present embodiment, after receiving the image editing request, the executing body may input the description text and the to-be-edited image into the image editing model, to generate the target image corresponding to the description text. The description text and the to-be-edited image may be input into a pre-trained image editing model, and the target image corresponding to the description text may be output from an output end of the image editing model.

In some alternative implementations of the present embodiment, the executing body may determine a text direction vector based on the description text and a predetermined text template, input the text direction vector into a mapping network of the image editing model to obtain a bias vector, and generate the target image based on the to-be-edited image and the bias vector.

In some alternative implementations of the present embodiment, the text direction vector may be determined by: obtaining a supplementary text based on the description text and the text template; inputting the text template and the supplementary text respectively into a text conversion network of the image editing model to obtain a template text vector and a supplementary text vector; and calculating the text direction vector based on the template text vector and the supplementary text vector.

In some alternative implementations of the present embodiment, the target image may be generated by: inputting the to-be-edited image into a vector generation network of the image editing model to obtain a basic image vector; and adding the base image vector and the bias vector, and inputting the added base image vector and bias vector into an image generation network of the image editing model to obtain the target image.

It can be seen from FIG. 5 that the method for editing an image in the present embodiment may directly generate the corresponding target image from any description text, improves the efficiency of image editing, saves costs, and improves user experience.

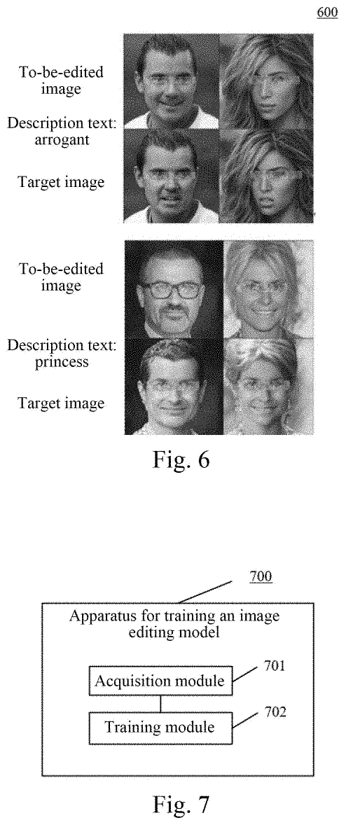

With further reference to FIG. 6, illustrating an effect schematic diagram 600 of the method for editing an image according to the present disclosure. As can be seen from FIG. 6, the description texts are “arrogant”, “princess”. A set of the description text “arrogant” and a to-be-edited image are input into the image editing model, and faces in the output target image show arrogant expressions, and another set of the description text “princess” and a to-be-edited image are input into the image editing model, and faces in the output target image show princess dress up. It can be seen that the trained image editing model may process any description text, which improves the efficiency of image editing.

With further reference to FIG. 7, as an implementation of the method for training an image editing model, the present disclosure provides an embodiment of an apparatus for training an image editing model, and the apparatus embodiment corresponds to the method embodiment shown in FIG. 2. The apparatus may be applied to various electronic devices.

As shown in FIG. 7, an apparatus 700 for training an image editing model in the present embodiment may include an acquisition module 701 and a training module 702. The acquisition module 701 is configured to acquire a training sample set, where training samples include description text samples and image samples. The training module 702 is configured to perform training steps as follows: selecting a description text sample and an image sample from the training sample set; determining a text direction vector based on the selected description text sample and a predetermined text template; inputting the text direction vector into a mapping network of the image editing model to obtain a bias vector; determining an image direction vector based on the selected image sample and the bias vector; calculating a loss value based on the text direction vector and the image direction vector; and determining, in response to the loss value meeting a threshold condition, that training of the image editing model is completed.

In the present embodiment, in the apparatus 700 for training an image editing model: for the specific processing and the technical effects of the acquisition module 701 and the training module 702, reference may be made to the relevant descriptions of steps 201-208 in the corresponding embodiment of FIG. 2 respectively, and detailed description thereof will be omitted.

In some alternative implementations of the present embodiment, the mapping network includes a fully connected layer and a mapping layer, and the training module 702 includes: a refactoring submodule, configured to input the text direction vector into the fully connected layer of the mapping network to obtain a refactored direction vector; and a mapping submodule, configured to input the refactored direction vector into the mapping layer of the mapping network to obtain the bias vector.

In some alternative implementations of the present embodiment, the image editing model further includes an image conversion network, and the training module 702 further includes: a first generation submodule, configured to generate an original image and an edited image based on the selected image sample and the bias vector; a second generation submodule, configured to input the original image and the edited image respectively into the image conversion network to obtain an original image vector and an edited image vector; and a first calculation submodule, configured to calculate the image direction vector based on the original image vector and the edited image vector.

In some alternative implementations of the present embodiment, the image editing model further includes a vector generation network and an image generation network, and the first generation submodule includes: a first generation unit, configured to input the selected image sample into the vector generation network to obtain a basic image vector; a second generation unit, configured to input the basic image vector into the image generation network to obtain the original image; and a third generation unit, configured to add the base image vector and the bias vector, and input the added base image vector and bias vector into the image generation network to obtain the edited image.

In some alternative implementations of the present embodiment, the image editing model further includes a text conversion network, and the training module 702 further includes: a third generation submodule, configured to obtain a supplementary text sample, based on the selected description text sample and the text template; a fourth generation submodule, configured to input the text template and the supplementary text sample respectively into the text conversion network to obtain a template text vector and a supplementary text vector; and a second calculation submodule, configured to calculate the text direction vector based on the template text vector and the supplementary text vector.

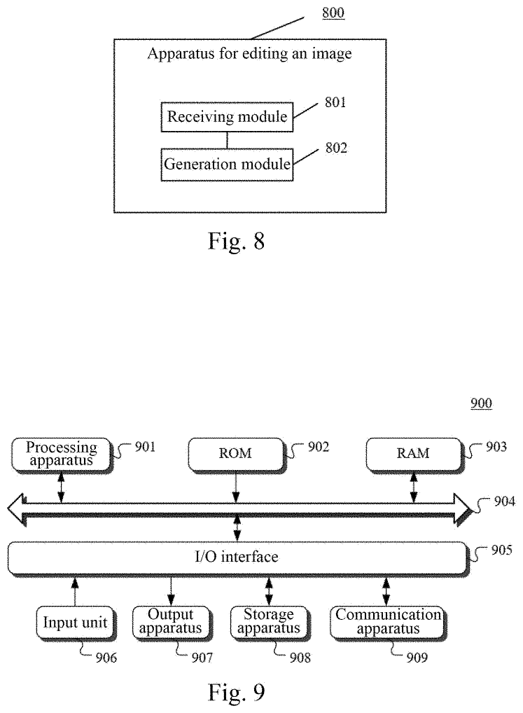

With further reference to FIG. 8, as an implementation of the method for editing an image, the present disclosure provides an embodiment of an apparatus for editing an image, and the apparatus embodiment corresponds to the method embodiment shown in FIG. 5. The apparatus may be applied to various electronic devices.

As shown in FIG. 8, an apparatus 800 for editing an image in the present embodiment may include a receiving module 801 and a generation module 802. The receiving module 801 is configured to receive an image editing request, where the image editing request includes a to-be-edited image and a description text. The generation module 802 is configured to input the description text and the to-be-edited image into an image editing model, to generate a target image corresponding to the description text.

In the present embodiment, in the apparatus 800 for editing an image: for the specific processing and the technical effects of the receiving module 801 and the generation module 802, reference may be made to the relevant descriptions of steps 501-502 in the corresponding embodiment of FIG. 5 respectively, and detailed description thereof will be omitted.

In some alternative implementations of the present embodiment, the generation module 802 includes: a determination submodule, configured to determine a text direction vector based on the description text and a predetermined text template; a fifth generation submodule, configured to input the text direction vector into a mapping network of the image editing model to obtain a bias vector; and a sixth generation submodule, configured to generate the target image based on the to-be-edited image and the bias vector.

In some alternative implementations of the present embodiment, the sixth generation submodule includes: a fourth generation unit, configured to input the to-be-edited image into a vector generation network of the image editing model to obtain a basic image vector; and a fifth generation unit, configured to add the base image vector and the bias vector, and input the added base image vector and bias vector into an image generation network of the image editing model to obtain the target image.

In some alternative implementations of the present embodiment, the determination submodule includes: a sixth generation unit, configured to obtain a supplementary text based on the description text and the text template; a seventh generation unit, configured to input the text template and the supplementary text respectively into a text conversion network of the image editing model to obtain a template text vector and a supplementary text vector; and a calculation unit, configured to calculate the text direction vector based on the template text vector and the supplementary text vector.

According to an embodiment of the present disclosure, the present disclosure also provides an electronic device, a readable storage medium, and a computer program product.

FIG. 9 illustrates a schematic block diagram of an example electronic device 900 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The parts shown herein, their connections and relationships, and their functions are merely examples, and are not intended to limit the implementation of the present disclosure described and/or claimed herein.

As shown in FIG. 9, the device 900 includes a computation unit 901, which may execute various appropriate actions and processes in accordance with a computer program stored in a read-only memory (ROM) 902 or a computer program loaded into a random access memory (RAM) 903 from a storage unit 908. The RAM 903 also stores various programs and data required by operations of the device 900. The computation unit 901, the ROM 902 and the RAM 903 are connected to each other through a bus 904. An input/output (I/O) interface 905 is also connected to the bus 904.

The following components in the electronic device 900 are connected to the I/O interface 905: an input unit 906, for example, a keyboard and a mouse; an output unit 907, for example, various types of displays and a speaker; a storage device 908, for example, a magnetic disk and an optical disk; and a communication unit 909, for example, a network card, a modem, a wireless communication transceiver. The communication unit 909 allows the device 900 to exchange information/data with an other device through a computer network such as the Internet and/or various telecommunication networks.

The computation unit 901 may be various general-purpose and/or special-purpose processing assemblies having processing and computing capabilities. Some examples of the computation unit 901 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computation unit 901 performs the various methods and processes described above, for example, the method for training an image editing model or editing an image. For example, in some embodiments, the method for training an image editing model or editing an image may be implemented as a computer software program, which is tangibly included in a machine readable medium, for example, the storage device 908. In some embodiments, part or all of the computer program may be loaded into and/or installed on the device 900 via the ROM 902 and/or the communication unit 909. When the computer program is loaded into the RAM 903 and executed by the computation unit 901, one or more steps of the above method for training an image editing model or editing an image may be performed. Alternatively, in other embodiments, the computation unit 901 may be configured to perform the method for training an image editing model or editing an image through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a distributed system server, or a server combined with a blockchain. The server may also be a cloud server, or an intelligent cloud computing server or intelligent cloud host with artificial intelligence technology.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for training an image editing model, the method comprising:
acquiring a training sample set, wherein training samples comprise description text samples and image samples; and
performing training steps as follows:
selecting a description text sample and an image sample from the training sample set;
determining a text direction vector based on the selected description text sample and a predetermined text template;
inputting the text direction vector into a mapping network of the image editing model to obtain a bias vector;
determining an image direction vector based on the selected image sample and the bias vector;
calculating a loss value based on the text direction vector and the image direction vector; and
determining, in response to the loss value meeting a threshold condition, that training of the image editing model is completed.

2. The method according to claim 1, wherein the mapping network comprises a fully connected layer and a mapping layer, and the inputting the text direction vector into a mapping network of the image editing model to obtain a bias vector, comprises:
inputting the text direction vector into the fully connected layer of the mapping network to obtain a refactored direction vector; and
inputting the refactored direction vector into the mapping layer of the mapping network to obtain the bias vector.

3. The method according to claim 2, wherein the image editing model further comprises an image conversion network, and the determining an image direction vector based on the selected image sample and the bias vector, comprises:
generating an original image and an edited image based on the selected image sample and the bias vector;
inputting the original image and the edited image respectively into the image conversion network to obtain an original image vector and an edited image vector; and
calculating the image direction vector based on the original image vector and the edited image vector.

4. The method according to claim 3, wherein the image editing model further comprises a vector generation network and an image generation network, and the generating an original image and an edited image based on the selected image sample and the bias vector, comprises:
inputting the selected image sample into the vector generation network to obtain a basic image vector;
inputting the basic image vector into the image generation network to obtain the original image; and
adding the base image vector and the bias vector, and inputting the added base image vector and bias vector into the image generation network to obtain the edited image.

5. The method according to claim 1, wherein the image editing model further comprises a text conversion network, and the determining a text direction vector based on the selected description text sample and a predetermined text template, comprises:
obtaining a supplementary text sample, based on the selected description text sample and the text template;
inputting the text template and the supplementary text sample respectively into the text conversion network to obtain a template text vector and a supplementary text vector; and
calculating the text direction vector based on the template text vector and the supplementary text vector.

6. A method for editing an image, the method comprising:
receiving an image editing request, wherein the image editing request comprises a to-be-edited image and a description text; and
inputting the description text and the to-be-edited image into an image editing model, to generate a target image corresponding to the description text, wherein the image editing model is trained according to operations for training an image editing model, the operations comprising:
acquiring a training sample set, wherein training samples comprise description text samples and image samples; and
performing training steps as follows:
selecting a description text sample and an image sample from the training sample set;
determining a text direction vector based on the selected description text sample and a predetermined text template;
inputting the text direction vector into a mapping network of the image editing model to obtain a bias vector;
determining an image direction vector based on the selected image sample and the bias vector;
calculating a loss value based on the text direction vector and the image direction vector; and
determining, in response to the loss value meeting a threshold condition, that training of the image editing model is completed.

7. The method according to claim 6, wherein the inputting the description text and the to-be-edited image into an image editing model, to generate a target image corresponding to the description text, comprises:
determining a text direction vector based on the description text and a predetermined text template;
inputting the text direction vector into a mapping network of the image editing model to obtain a bias vector; and
generating the target image based on the to-be-edited image and the bias vector.

8. The method according to claim 7, wherein the generating the target image based on the to-be-edited image and the bias vector, comprises:
inputting the to-be-edited image into a vector generation network of the image editing model to obtain a basic image vector; and
adding the base image vector and the bias vector, and inputting the added base image vector and bias vector into an image generation network of the image editing model to obtain the target image.

9. The method according to claim 8, wherein the determining a text direction vector based on the description text and a predetermined text template, comprises:
obtaining a supplementary text based on the description text and the text template;
inputting the text template and the supplementary text respectively into a text conversion network of the image editing model to obtain a template text vector and a supplementary text vector; and
calculating the text direction vector based on the template text vector and the supplementary text vector.

10. An electronic device, comprising:
at least one processor; and
a storage device that stores instructions that, when executed by the at least one processor, causes the at least one processor to perform first operations for training an image editing model, the first operations comprising:
acquiring a training sample set, wherein training samples comprise description text samples and image samples; and
performing training steps as follows:
selecting a description text sample and an image sample from the training sample set;
determining a text direction vector based on the selected description text sample and a predetermined text template;
inputting the text direction vector into a mapping network of the image editing model to obtain a bias vector;
determining an image direction vector based on the selected image sample and the bias vector;
calculating a loss value based on the text direction vector and the image direction vector; and
determining, in response to the loss value meeting a threshold condition, that training of the image editing model is completed.

11. The electronic device according to claim 10, wherein the mapping network comprises a fully connected layer and a mapping layer, and the inputting the text direction vector into a mapping network of the image editing model to obtain a bias vector, comprises:
inputting the text direction vector into the fully connected layer of the mapping network to obtain a refactored direction vector; and
inputting the refactored direction vector into the mapping layer of the mapping network to obtain the bias vector.

12. The electronic device according to claim 11, wherein the image editing model further comprises an image conversion network, and the determining an image direction vector based on the selected image sample and the bias vector, comprises:
generating an original image and an edited image based on the selected image sample and the bias vector;
inputting the original image and the edited image respectively into the image conversion network to obtain an original image vector and an edited image vector; and
calculating the image direction vector based on the original image vector and the edited image vector.

13. The electronic device according to claim 12, wherein the image editing model further comprises a vector generation network and an image generation network, and the generating an original image and an edited image based on the selected image sample and the bias vector, comprises:
inputting the selected image sample into the vector generation network to obtain a basic image vector;
inputting the basic image vector into the image generation network to obtain the original image; and
adding the base image vector and the bias vector, and inputting the added base image vector and bias vector into the image generation network to obtain the edited image.

14. The electronic device according to claim 10, wherein the image editing model further comprises a text conversion network, and the determining a text direction vector based on the selected description text sample and a predetermined text template, comprises:
obtaining a supplementary text sample, based on the selected description text sample and the text template;
inputting the text template and the supplementary text sample respectively into the text conversion network to obtain a template text vector and a supplementary text vector; and
calculating the text direction vector based on the template text vector and the supplementary text vector.

15. The electronic device according to claim 10, wherein the storage device causes the at least one processor to perform second operations for editing an image, the second operations comprising:
receiving an image editing request, wherein the image editing request comprises a to-be-edited image and a description text; and
inputting the description text and the to-be-edited image into an image editing model, to generate a target image corresponding to the description text, wherein the image editing model is trained according to the first operations.

16. The electronic device according to claim 15, wherein the inputting the description text and the to-be-edited image into an image editing model, to generate a target image corresponding to the description text, comprises:
determining a text direction vector based on the description text and a predetermined text template;
inputting the text direction vector into a mapping network of the image editing model to obtain a bias vector; and
generating the target image based on the to-be-edited image and the bias vector.

17. The electronic device according to claim 16, wherein the generating the target image based on the to-be-edited image and the bias vector, comprises:
inputting the to-be-edited image into a vector generation network of the image editing model to obtain a basic image vector; and
adding the base image vector and the bias vector, and inputting the added base image vector and bias vector into an image generation network of the image editing model to obtain the target image.

18. The electronic device according to claim 17, wherein the determining a text direction vector based on the description text and a predetermined text template, comprises:
obtaining a supplementary text based on the description text and the text template;
inputting the text template and the supplementary text respectively into a text conversion network of the image editing model to obtain a template text vector and a supplementary text vector; and
calculating the text direction vector based on the template text vector and the supplementary text vector.
